(19) United States
(12) Patent Application Publication
(10) Pub. No.: US 2025/0333010 A1
(43) Pub. Date: Oct. 30, 2025

(54) METHODS AND APPARATUS TO DETERMINE A VEHICLE PITCH ANGLE FOR LUMINOUS RANGE CONTROL

(71) Applicant: Ford Global Technologies, LLC, Dearborn, MI (US)

(72) Inventors: Matthias Christian Reiter, Aachen (DE); Lars Michael Lottner, Odenthal (DE); Max Anton Schumacher, Köln (DE); Jannis Koenkes, Bonn (DE)

(21) Appl. No.: 19/190,112

(22) Filed: Apr. 25, 2025

(30) Foreign Application Priority Data
Apr. 29, 2024 (DE) 102024111966.7

(51) Int. Cl. B60R 16/023; B60Q 1/115

(52) U.S. Cl. CPC B60R 16/0233; B60Q 1/115; B60Q 2300/114; B60Q 2300/116; B60Q 2300/132

(57) ABSTRACT

Methods and apparatus to determine a vehicle pitch angle for luminous range control are disclosed. An example method to determine a pitch angle of a vehicle relative to a surface on which the vehicle stands for luminous range control of a headlight of the vehicle includes determining, at a standstill of the vehicle, a change of a load pitch angle of the vehicle based on output from a gravitation sensor, determining, as the vehicle is driven, an average value of the pitch angle of the vehicle and an average value of a dynamic pitch angle of the vehicle, the average value of the dynamic pitch angle determined via output from an acceleration sensor, determining a current value of the dynamic pitch angle via the output from the acceleration sensor, determining a current value of the load pitch angle of the vehicle based on the average value of the pitch angle and the average value of the dynamic pitch angle, determining, based on the current value of the load pitch angle and the current value of the dynamic pitch angle, the pitch angle of the vehicle relative to the surface, and controlling an orientation of the headlight of the vehicle based on the pitch angle of the vehicle relative to the surface.

### RELATED APPLICATION

This patent claims priority from DE Patent Application Number 10 2024 111 966.7, which was filed on Apr. 29, 2024, and is hereby incorporated herein by reference in its entirety.

### FIELD OF THE DISCLOSURE

The disclosure relates to a method for determining the current pitch angle of a vehicle in relation to the underlying surface, thus the roadway, for automatic luminous range control of at least one headlight of the vehicle. The disclosure further relates to a method and apparatus for luminous range control of at least one headlight of a vehicle.

### BACKGROUND

As used herein, the term “pitch angle” refers to the present angle of a vehicle above the ground. The pitch angle can be quickly variable and is influenced by the loading of the vehicle, the vehicle longitudinal dynamics, in particular braking, acceleration, as well as uphill and downhill due to additional force requirement, and also by random roadway irregularities. Presently, the factory state or calibration state or the state of an unloaded vehicle is defined as a state having a pitch angle of zero degrees. All other angles describe a deviation from the factory state or from the unloaded state.

### SUMMARY

An example method to determine a pitch angle of a vehicle relative to a surface on which the vehicle stands for luminous range control of a headlight of the vehicle includes determining, at a standstill of the vehicle, a change of a load pitch angle of the vehicle based on output from a gravitation sensor, determining, as the vehicle is driven, an average value of the pitch angle of the vehicle and an average value of a dynamic pitch angle of the vehicle, the average value of the dynamic pitch angle determined via output from an acceleration sensor, determining a current value of the dynamic pitch angle via the output from the acceleration sensor, determining a current value of the load pitch angle of the vehicle based on the average value of the pitch angle and the average value of the dynamic pitch angle, determining, based on the current value of the load pitch angle and the current value of the dynamic pitch angle, the pitch angle of the vehicle relative to the surface, and controlling an orientation of the headlight of the vehicle based on the pitch angle of the vehicle relative to the surface.

An example apparatus for luminous range control of a headlight of a vehicle includes a gravitation sensor for determining, at a standstill of the vehicle, a change of a load pitch angle of the vehicle, an acceleration sensor for determining an average value of the pitch angle of the vehicle and an average value of a dynamic pitch angle of the vehicle as the vehicle is driven in a calibration phase, and a current value of the dynamic pitch angle, machine readable instructions, and programmable circuitry to execute the instructions to determine a current value of the load pitch angle of the vehicle based on the average value of the pitch angle and the average value of the dynamic pitch angle, determine, based on the current value of the load pitch angle and the current value of the dynamic pitch angle, a pitch angle of the vehicle relative to a surface on which the vehicle stands, and control an orientation of the headlight of the vehicle based on the pitch angle of the vehicle relative to the surface.

An example non-transitory machine readable storage medium includes instructions to cause programmable circuitry to at least determine, at a standstill of a vehicle, a change of a load pitch angle of the vehicle, determine, as the vehicle is driven, (i) an average value of a pitch angle of the vehicle and (ii) an average value of a dynamic pitch angle of the vehicle, determine a current value of the dynamic pitch angle, determine a current value of the load pitch angle based on the average value of the pitch angle and the average value of the dynamic pitch angle, determine, based on the current value of the load pitch angle and the current value of the dynamic pitch angle, the pitch angle of the vehicle, and control an orientation of a headlight of the vehicle based on the pitch angle of the vehicle.

### BRIEF DESCRIPTION OF THE DRAWINGS

FIG. 1 schematically shows a method according to examples disclosed herein for determining the current pitch angle of a vehicle in relation to the underlying surface for luminous range control in the form of a flow chart.

FIG. 2 schematically shows a method according to examples disclosed herein for luminous range control in the form of a flow chart.

FIG. 3 schematically shows a motor vehicle according to examples disclosed herein having a device according to examples disclosed herein for luminous range control.

FIG. 4 is a block diagram of an example programmable circuitry platform 400 structured to execute and/or instantiate the example machine-readable instructions and/or the example operations of FIGS. 1 and 2 to implement examples disclosed herein.

In general, the same reference numbers will be used throughout the drawing(s) and accompanying written description to refer to the same or like parts. The figures are not necessarily to scale.

### DETAILED DESCRIPTION

Methods and apparatus to determine a vehicle pitch angle for luminous range control are disclosed. An averaged pitch angle is understood to be the measured angle of a system which determines an averaged pitch angle during the journey (e.g., a camera that determines a horizon angle via a sequence of images). The loading pitch angle can be understood to be the quasistatic component of the pitch angle which depends only on the loading, but not the driving situation. The loading pitch angle corresponds to the angle, which results at a standstill in the plane. The dynamic pitch angle is understood to be the current, thus the present, rapidly variable, deviation of the pitch angle from the loading pitch angle, thus the part of the pitch angle which depends on the driving situation (braking, acceleration, uphill, downhill).

To determine the dynamic pitch angle, the longitudinal acceleration of the vehicle can be measured, which generally correlates very well with the dynamic pitch angle, since the dynamic pitch angle is primarily caused by acceleration forces which engage on a predominantly linearly suspended system.

Systems for automatic luminous range control (e.g., regulation) require as an essential input variable the current loading pitch angle (pitch angle) of the vehicle in relation to the roadway. A change of the pitch angle can in particular occur as a result of the driving style or as a result of loading or unloading of the vehicle, for example a passenger vehicle having a loaded baggage compartment. If the loading pitch angle changes, the headlights have to be readjusted, thus corrected upward or downward with respect to their emission angle. For motor vehicles permitted in the EU, automatic luminous range control systems are obligatory for certain types of headlights. A dynamic adaptation of the emission angle to the driving situation which goes beyond the compensation of the loading pitch angle is not compulsory, but is certainly advantageous. A reduction of the visible range is thus counteracted during braking.

Presently, the pitch angle of a vehicle is typically determined using two mechanical ride height sensors, wherein a first ride height sensor is attached to the front axle and a second ride height sensor is attached to the rear axle. The ride height sensors supply information about a height change of the suspension, wherein an electrical output signal of the ride height sensor changes depending on the suspension height of the vehicle.

This signal can be used by a control unit, for example a luminous range control module (e.g., a headlamp control module (HCM)), for calculating the pitch angle and for controlling a stepping motor within the headlight for its adjustment. In combination with knowledge of the wheelbase, a direct, precise, and rapid method is therefore available for determining the change of the pitch angle of a vehicle, for example due to additional loading or other factors. Other variants also exist, which are only based on one ride height sensor, typically on the rear axle.

However, the aforementioned sensors can be complex to integrate onto existing vehicles. Moreover, the sensors can be maintenance-intensive, since they are subjected directly to the environmental influences, thus, for example, the weather and mechanical influences due to the roadway, in particular possible rock strikes. It is therefore desirable to replace the above-described solution based on mechanical sensors with alternatives.

Known methods are capable of determining an averaged pitch angle in relation to the roadway via images captured by a camera, for example a front camera. The averaged pitch angle is typically determined while driving. Since the pitch angle of the vehicle can vary depending on the driving conditions, for example, the pitch angle can change in relation to an uphill or downhill journey. Further, the average pitch angle determined via the camera also deviates from the pitch angle of the vehicle that occurs when the vehicle comes to a standstill in a horizontal plane (e.g., a loading pitch angle). A system for luminous range control can utilize this loading pitch angle as the output variable, however. A loading pitch angle can be determined reliably from an averaged pitch angle and further variables by known methods. Furthermore, methods are known that can determine a loading pitch angle on the basis of a single ride height sensor, usually attached to the rear axle, with reduced accuracy, which is generally sufficient, however. The background for this is that the effect of typical loading states on the static deflection of the front axle is comparatively minor.

Known methods and devices for luminous range control using a camera are described in documents DE 10 2017 005 019 A1, DE 10 2020 128 440 A1, DE 10 2011 017 697 A1, US 2021/0 323 466 A1, and US 2017/0 225 609 A1. Various sensors are used in conjunction with the luminous range control in document U.S. Pat. No. 10,953,787 B2. Further known documents include EP 2 130 718 A2, CN 112477750 B, DE 10 2021 006290 A1, EP 0 709 240 A1, U.S. Pat. Nos. 6,693,380 B2, 6,450,673 B1, 6,193,398 B1, 9,260,051 B2, US 2016/0 288 698 A1, JP 5597472 B2, U.S. Pat. Nos. 10,676,016 B2, 11,390,207 B2, DE 10 2019 000 942 A1, US 2022 0 212 600 A1, US 2023 0 182 637 A1, U.S. Pat. No. 9,908,458 B2, WO 2023 090 327 A1, WO 2023 067 978 A1, and US 2014/0 301 094 A1.

The use of acceleration signals for determining or estimating the dynamic pitch angle, for example with function tables, for the purpose of luminous range control is known. The dynamic pitch angle, thus the deviation of the current pitch angle of the vehicle from the loading pitch angle, is strongly correlated with the longitudinal acceleration. The longitudinal acceleration is therefore well suitable for determining pitching movements caused by the movement of the vehicle, such as acceleration, braking, uphill driving, or downhill driving, beforehand. In addition, improved determination beforehand can be enabled by incorporating further measured variables, although less relevant, such as the velocity or the loading.

Against this background, it is an object of examples disclosed herein to provide an advantageous method for determining the current pitch angle of a vehicle in relation to the underlying surface for automatic luminous range control. Further objects are to provide an advantageous method and apparatus for luminous range control.

These objects are achieved by a method for determining the current pitch angle of a vehicle in relation to the underlying surface, a method for luminous range control, a device for luminous range control, a vehicle, a computer-implemented method, a computer program product, a computer-readable data carrier, and a data carrier signal.

A method according to examples disclosed herein for determining, in particular for estimating or calculating, the current pitch angle of a vehicle in relation to the underlying surface for automatic luminous range control of at least one headlight, for example a front headlight, of the vehicle relates to a vehicle which comprises at least one apparatus for ascertaining an averaged pitch angle of the vehicle, for example a camera, at least one acceleration sensor for determining the longitudinal acceleration of the vehicle, and at least one gravitation sensor.

An acceleration sensor for determining the longitudinal acceleration of the vehicle is understood here as an acceleration sensor which is designed to determine the acceleration of the vehicle in the direction of a longitudinal axis of the vehicle, thus in the direction of an x axis of a coordinate system related to the vehicle. A gravitation sensor is may be implemented as an acceleration sensor which is designed to determine the inclination of the vehicle in relation to the gravitation or the direction of the gravitational force. In other words, the gravitation sensor is designed to determine the inclination of a longitudinal axis of the vehicle, thus an x axis of a coordinate system related to the vehicle, and/or a vertical axis of the vehicle, thus a z axis of a coordinate system related to the vehicle, in relation to the direction of the gravitation. In a typical motor vehicle, both the determination of the longitudinal acceleration and the function of the gravitation sensor could be carried out on the basis of a longitudinally installed acceleration sensor. Such an acceleration sensor is already installed in nearly all vehicles as a sensor system for vehicle dynamics control systems.

A method according to examples disclosed herein comprises the following operations. At a standstill of the vehicle, a change of the loading pitch angle of the vehicle is determined via the gravitation sensor. The change can also be zero if the loading of the vehicle has not changed during the standstill. When the vehicle is driving, an average pitch angle of the vehicle during a calibration time window is determined via the apparatus for ascertaining an averaged pitch angle. Furthermore, when the vehicle is driving, an average dynamic pitch angle of the vehicle during the calibration time window of the apparatus for ascertaining an averaged pitch angle is determined via data of the at least one acceleration sensor, as well as further measured variables, for example. Moreover, a current dynamic pitch angle of the vehicle is determined via data of the at least one acceleration sensor, and further measured variables, for example. In general, the dynamic pitch angle is correlated very dominantly with the longitudinal acceleration of the vehicle, so that the use of further measured variables for determining the dynamic pitch angle is not explicitly mentioned hereinafter. Further variables, the usage of which can additionally improve the determination of the dynamic pitch angle, are, for example, the vehicle velocity, the loading state, information on trailer loads, or information on the state of the drivetrain.

In a further operation, a current loading pitch angle of the vehicle is determined based on the average pitch angle determined via the apparatus for ascertaining an averaged pitch angle and the average dynamic pitch angle determined via the at least one acceleration sensor. Preferably, to determine the current loading pitch angle, the determined average dynamic pitch angle is subtracted during the ascertainment of the averaged pitch angle from the ascertained averaged pitch angle. The current pitch angle of the vehicle in relation to the underlying surface, thus in relation to the roadway, is then determined based on the determined current loading pitch angle and the determined current dynamic pitch angle of the vehicle. Preferably, the determined current dynamic pitch angle is added to the determined current loading pitch angle.

A method according to examples disclosed herein has the advantage that examples disclosed herein enable relatively rapid and reliable determination of the current pitch angle of a vehicle for automatic luminous range control and therefore contributes to improving the reliability as well as reducing the reaction time of the automatic luminous range control. A method according to examples disclosed herein has the advantage that without the ride height sensors described at the outset, a current pitch angle can be determined reliably. Therefore, the use of ride height sensors can possibly be omitted in the future in conjunction with luminous range control.

In the scope of examples disclosed herein for determining the current pitch angle, two procedures or methods are combined with one another to determine the quasistatic loading pitch angle, during the journey, and a further method is used to determine, building thereon, the dynamically rapidly changing, current pitch angle.

On the one hand, the current loading pitch angle is determined based on an averaged pitch angle for example using a camera system. The camera system can calculate a mean pitch angle based on data captured in a defined calibration time window. In consideration of the mean dynamic pitch angle during the calibration time window, the loading pitch angle can be derived from the averaged pitch angle. On the other hand, changes of the loading pitch angle are tracked during a standstill of the vehicle. For this purpose, changes of the gravitation angle during loading or unloading of the vehicle can be observed and tracked. While a camera system requires a movement of the vehicle to ascertain an averaged pitch angle to determine the loading pitch angle, and is therefore first available in the course of the journey, a system for observing and tracking the gravitation angle can also be applied at a standstill of the vehicle. By adding a dynamic pitch angle determined by an acceleration sensor, the current pitch angle can moreover be ascertained building on the loading pitch angle. A pitch angle signal which is precise and highly available and meets high dynamic requirements can be determined by the described combination of the individual procedures.

The precision can be achieved in examples disclosed herein by using a system for determining a pitch angle averaged over a calibration time window, for example based on a camera. The loading pitch angle can be concluded precisely from this averaged pitch angle, preferably using an average dynamic pitch angle in the calibration time window determined in parallel. The high level of availability is achieved by combining the system with gravitation-based tracking of the loading pitch angle at a standstill. Without the gravitation-based tracking, a loading change would first be detected after a certain driving distance and would not be available from the start. At the same time, a system for gravitation-based tracking of the loading pitch angle also could not be used alone, since it is based on the principle of the accumulation of changes and measuring errors would be added up over time, the camera-based determination of the loading pitch angle is also used here to correct and reset accumulated errors. The high level of dynamics is achieved by the model-based determination of the dynamic pitch angle via an acceleration sensor, which, in combination with the previously determined quasistatic loading pitch angle, permits dynamically reacting to the driving situation as well.

Examples disclosed herein advantageously enable simple retrofitting or supplementing of existing systems because existent sensors can be utilized.

In one example, the change of the loading pitch angle of the vehicle at a standstill is determined by the gravitation sensor in relation to a stored gravitation angle, for example stored in a nonvolatile memory, thus an angle of a longitudinal axis (x axis) or vertical axis (z axis) of the vehicle in relation to the gravitation direction. In this way, a change of the loading pitch angle during the standstill, for example as a result of a change of the loading of the vehicle, can be taken into consideration immediately upon a subsequent start of the vehicle. Therefore, no time windows arise in which the luminous range is set based on a not yet updated loading pitch angle.

The current dynamic pitch angle of the vehicle can be determined, in particular calculated or estimated, based on a model for determining the dynamic pitch angle, for example using at least one characteristic map, for example in the form of a lookup table and/or a curve and/or a function, for example a characteristic function and/or a mapping function.

An averaged pitch angle can be determined while the vehicle is driving using a camera system, which uses data recorded within a calibration window to determine an averaged pitch angle of the vehicle during the calibration time window.

The average dynamic pitch angle of the vehicle during the calibration time window of the apparatus for ascertaining an averaged pitch angle can be determined, in particular calculated or estimated, with a model for determining the dynamic pitch angle, for example using at least one characteristic map, for example in the form of a lookup table and/or a curve and/or a function, for example a characteristic function and/or a mapping function.

The current loading pitch angle of the vehicle can be determined, in particular calculated or estimated, from the averaged pitch angle and the average dynamic pitch angle during the calibration time window by at least one characteristic map, for example as a lookup table and/or a curve and/or a function, for example a characteristic function and/or a mapping function. In particular, the current loading pitch angle of the vehicle can be determined by subtraction of the average dynamic pitch angle of the vehicle during the calibration time window of the apparatus for ascertaining an averaged pitch angle from the averaged pitch angle of the same calibration time window of the apparatus for ascertaining an averaged pitch angle.

The examples mentioned enable simple, reliable, and cost-effective determination of the respective pitch angle or pitch angle component

In one advantageous example, when the vehicle comes to a standstill or stops, the gravitation angle is determined and stored. The gravitation angle can be determined here via the gravitation sensor. The gravitation angle thus determined and stored can be used as a reference variable for determining a, for example, loading-related change of the loading pitch angle of the vehicle at a standstill.

As already mentioned above, at least one camera can be used as an apparatus for ascertaining an averaged pitch angle of the vehicle.

A method according to examples disclosed herein for luminous range control of at least one headlight, for example a front headlight, of a vehicle comprises the following operations. Initially, a setting position of the at least one headlight is ascertained. One condition for this is an adjustment of the zero angle. With nominal base setting of a stepping motor angle, the headlight is thus calibrated as part of the installation so that a defined light emergence pitch is achieved. Normally, the headlight is set (e.g., on the actuation side) to a “zero position” at the end of the production line. Since the headlights as component and the headlight installation in the overall vehicle system include large mechanical tolerances, the angle is then corrected via adjusting screws (or electronic actuation) so that the light emerges at a fixed angle. This procedure is also referred to as “setting” or “aiming” and provides the setting position as a condition for any further compensation. The subsequent luminous range control or “leveling” ascertains changes in the angle between vehicle and ground and compensates for the fixed light emergence angle or the deviation from the setting position for this purpose.

Subsequent to the ascertainment of the setting position of the at least one headlight, the current pitch angle of the vehicle in relation to the underlying surface is determined by an above-described method according to examples disclosed herein. In a next operation, the deviation of the pitch angle of the vehicle from the setting position and therefore the resulting deviation of the at least one headlight from the setting position is ascertained. In particular, a new target angle can be defined. The setting, in particular the light emergence angle, of the at least one headlight is then adapted according to the ascertained deviation. In particular, the defined new target angle can be actuated here. The luminous range control can be carried out by mechanical rotation of a pivot frame by the required angle, for example via a stepping motor. With high-resolution pixel headlights, it is also possible to switch rows of pixels on or off in order not to emit light above the desired light-dark boundary. In other words, a change in the light emergence angle is thus compensated for.

A method according to examples disclosed herein for luminous range control has the features and advantages already described in conjunction with the method according to examples disclosed herein for determining the current pitch angle of the vehicle in relation to the underlying surface.

A device according to examples disclosed herein for luminous range control of at least one headlight of a vehicle relates to a device or a vehicle which comprises at least one apparatus for ascertaining an averaged pitch angle of the vehicle, at least one acceleration sensor for determining the longitudinal acceleration of the vehicle, and at least one gravitation sensor. The device according to examples disclosed herein for luminous range control is designed to receive data of the at least one apparatus for ascertaining an averaged pitch angle of the vehicle, the at least one acceleration sensor for determining the longitudinal acceleration of the vehicle, and the at least one gravitation sensor, and to carry out an above-described method according to examples disclosed herein for luminous range control. The device according to examples disclosed herein for luminous range control has the features and advantages already described in conjunction with the methods according to examples disclosed herein.

In a further example, the apparatus for ascertaining an averaged pitch angle can comprise a surroundings capture device, for example a camera, such as a front camera. The apparatus for ascertaining an averaged pitch angle can be designed here for capturing the roadway located in front of the vehicle and/or for ascertaining an averaged pitch angle of the vehicle.

A vehicle according to examples disclosed herein comprises an above-described device for luminous range control. The vehicle has the advantages already described. The vehicle can be an electric vehicle or a hybrid vehicle (HEV—hybrid electric vehicle). The vehicle can be a motor vehicle (e.g., a passenger vehicle, a truck, a bus, a minivan, a motorcycle, a moped, etc.).

A computer-implemented method according to examples disclosed herein comprises commands which, upon the execution of a program by a computer, cause the computer to carry out an above-described method according to examples disclosed herein. The computer program product according to examples disclosed herein comprises commands which, upon the execution of the program by a computer, cause the computer to carry out an above-described method according to examples disclosed herein. The computer program product according to examples disclosed herein is stored on the computer-readable data carrier according to examples disclosed herein. The data carrier signal according to examples disclosed herein transmits the computer program product according to examples disclosed herein. The computer-implemented method according to examples disclosed herein, the computer program product according to examples disclosed herein, the computer-readable data carrier according to examples disclosed herein, and the data carrier signal according to examples disclosed herein have the features and advantages already mentioned above.

Examples disclosed herein will be explained in more detail hereinafter on the basis of examples with reference to the figures. Although examples disclosed herein are illustrated and described in more detail by the preferred exemplary embodiments, examples disclosed herein are not thus restricted by the disclosed examples and other variations can be derived therefrom by a person skilled in the art without departing from the scope of protection of the disclosure.

The figures are not necessarily faithful in detail and to scale and can be shown magnified or shrunk in order to offer a better overview. Therefore, functional details disclosed here are not to be understood as restrictive, but only as an illustrative basis which offers a person of ordinary skill in the art in this area of technology instruction in implementing the examples disclosed herein in a variety of ways.

The expression “and/or” used here, when it is used in a series of two or more elements, means that each of the listed elements can be used alone, or any combination of two or more of the listed elements can be used. For example, if a combination is described which contains components A, B, and/or C, the combination can contain A alone; B alone; C alone; A and B in combination; A and C in combination; B and C in combination; or A, B, and C in combination.

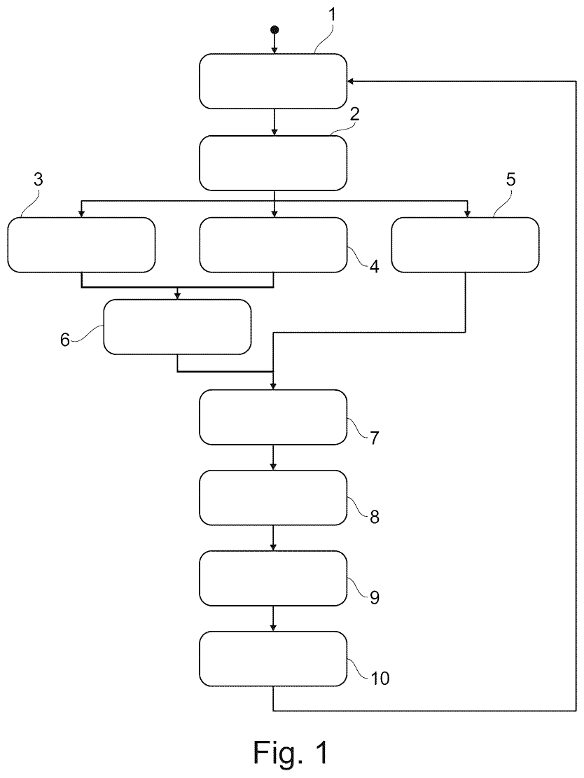

FIG. 1 schematically shows a method according to examples disclosed herein for determining the current pitch angle of a vehicle in relation to the underlying surface in the form of a flow chart. In operation 1, at a standstill of the vehicle, a change of the loading-related vehicle inclination, thus the loading pitch angle of the vehicle, is determined by a gravitation sensor. A stored gravitation angle can be utilized as a comparison variable. In operation 2, the vehicle goes into motion.

In operation 3, the average dynamic vehicle inclination, thus the average dynamic pitch angle of the vehicle, is determined during a calibration time window of an apparatus for ascertaining an averaged pitch angle, for example a camera. Characteristic maps can optionally be used in such an example. In operation 4, the averaged vehicle inclination above ground, thus the average pitch angle of the vehicle, is determined via an apparatus for ascertaining an averaged pitch angle, for example a camera. In operation 5, a current dynamic pitch angle of the vehicle is determined by with the at least one acceleration sensor, possibly using characteristic maps.

In operation 6, a current loading pitch angle of the vehicle is determined based on the average pitch angle determined by the apparatus for ascertaining an averaged pitch angle and the average dynamic pitch angle determined via the acceleration sensor. In other words, a loading-related vehicle inclination is, thus, determined by an acceleration sensor, possibly using characteristic maps, and the apparatus, which is camera-based, for example, for ascertaining an averaged pitch angle.

In operation 7, the current pitch angle of the vehicle above the underlying surface or in relation to the roadway is determined based on the current dynamic pitch angle determined in operation 5 and the current loading pitch angle determined in operation 6. In other words, the current vehicle inclination above ground is determined.

In operation 8, in the context of a luminous range control, the pitch of the light cone of the low beam can then be adapted to the current vehicle inclination above ground or the current pitch angle of the vehicle above the underlying surface.

In operation 9, the vehicle comes to a standstill or stops the longitudinal movement. In operation 10, the gravitation angle is then ascertained with the gravitation sensor and stored in addition to the last ascertained loading pitch angle, in particular when the vehicle is switched off. The method is then continued or repeated with operation 1. In turn, the example method returns to operation 1.

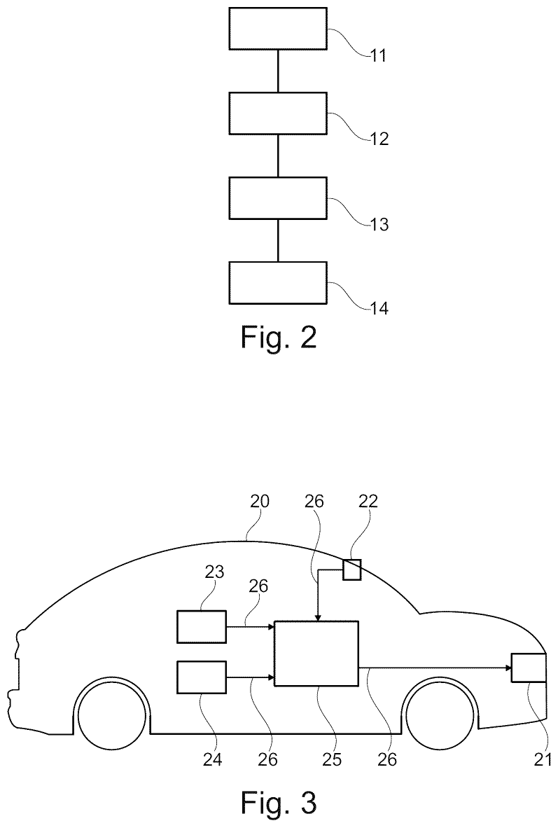

FIG. 2 schematically shows a method according to examples disclosed herein for luminous range control in the form of a flow chart. In operation 11, a setting position of the at least one headlight is ascertained to control the luminous range. One condition for this is an adjustment of the zero angle. With a nominal base setting of a stepping motor angle, the headlight is thus calibrated as part of the installation so that a defined light emergence pitch is achieved. A mechanical and/or optical calibration of the headlight thus takes place (headlight setting). A zero angle can be commanded to the luminous range setting, which then is also approached by this setting. At the same time, a determination of the corresponding loading pitch angle (reference loading angle, zero loading angle) can take place, for example, in a reference station having known targets.

In operation 12, the current pitch angle of the vehicle above the underlying surface, thus the roadway, is determined, for example with the aid of a method explained in connection with FIG. 1. In operation 13, based on the determined current pitch angle of the vehicle above the underlying surface, the deviation of the current pitch angle from the setting position and therefore the deviation of the headlight from the setting position resulting therefrom is ascertained. In this context, a new target angle can be defined. In operation 14, the setting, in particular the light emergence angle of the at least one headlight, is then adapted according to the ascertained deviation, thus, for example, the defined new target angle is actuated.

Example instructions and/or operations of FIGS. 1 and 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 3 schematically shows a motor vehicle 20 according to examples disclosed herein having a device 25 for luminous range control. The motor vehicle 20 and/or the device 25 for luminous range control comprises at least one headlight 21, for example a front headlight, at least one gravitation sensor 24, at least one acceleration sensor 23 for determining the longitudinal acceleration of the vehicle, and an apparatus 22 for ascertaining an averaged pitch angle of the vehicle, in particular a surroundings-capture device 22, for example in the form of a camera, which can be attached in particular on a windshield. The device for luminous range control 25 is designed to receive data of the gravitation sensor 24, the acceleration sensor 23, and the apparatus 22 for ascertaining an averaged pitch angle and to carry out a method according to examples disclosed herein for luminous range control, for example a method described on the basis of FIG. 1.

The data transfer is identified in each case by arrows having the reference sign 26 in FIG. 3. For the setting, in particular for the control or control, of the luminous range of the headlight 21, the device for luminous range control 25 transmits corresponding data to a control unit, for example to control a stepping motor within the headlight 21.

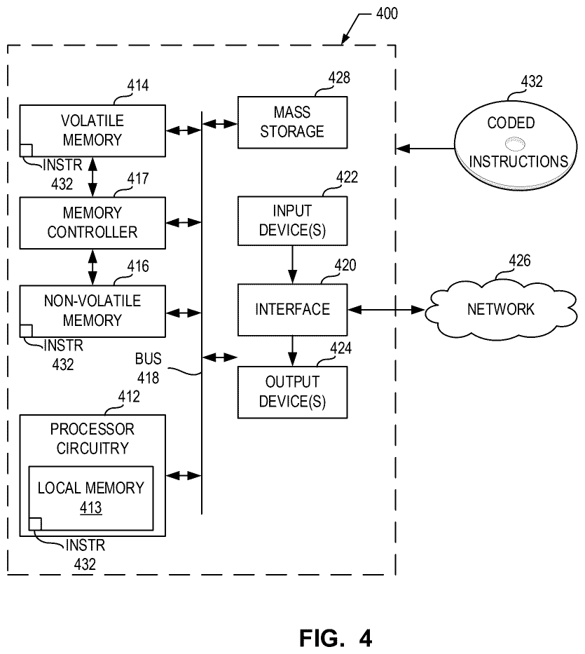

FIG. 4 is a block diagram of an example programmable circuitry platform 400 structured to execute and/or instantiate the example machine-readable instructions and/or the example operations of FIGS. 1 and 2 to implement examples disclosed herein. The programmable circuitry platform 400 can be, for example, a control device, an electronic control unit (ECU), a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 412 may be implemented by one or more semiconductor based (e.g., silicon based) devices.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a button, a touchscreen, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 432, which may be implemented by the machine-readable instructions of FIGS. 1 and 2, may be stored in the mass storage device 428, in the volatile memory 414, in the non-volatile memory 416, and/or on at least one non-transitory computer readable storage medium such as a CD or DVD which may be removable.

Example methods, apparatus, systems, and articles of manufacture to enable effective and relatively rapid control of headlights are disclosed herein. Further examples and combinations thereof include the following:
Example 1 includes a method to determine a pitch angle of a vehicle relative to a surface on which the vehicle stands for luminous range control of a headlight of the vehicle, the method comprising determining, at a standstill of the vehicle, a change of a load pitch angle of the vehicle based on output from a gravitation sensor, determining, as the vehicle is driven, an average value of the pitch angle of the vehicle and an average value of a dynamic pitch angle of the vehicle, the average value of the dynamic pitch angle determined via output from an acceleration sensor, determining a current value of the dynamic pitch angle via the output from the acceleration sensor, determining a current value of the load pitch angle of the vehicle based on the average value of the pitch angle and the average value of the dynamic pitch angle, determining, based on the current value of the load pitch angle and the current value of the dynamic pitch angle, the pitch angle of the vehicle relative to the surface, and controlling an orientation of the headlight of the vehicle based on the pitch angle of the vehicle relative to the surface.
Example 2 includes the method according to Claim 1, wherein the average value of the pitch angle and the average value of the dynamic pitch value are determined during a calibration time window based on the determination of the change of the load pitch angle of the vehicle.
Example 3 includes the method according to Claim 1, wherein the change of the load pitch angle of the vehicle is determined based on a measured gravitation angle of the gravitation sensor in relation to a stored gravitation angle.
Example 4 includes the method according to Claim 1, wherein the current value of the dynamic pitch angle of the vehicle is determined based on a model.
Example 5 includes the method according to Claim 1, wherein the average value of the dynamic pitch angle is determined based on a model for determining the dynamic pitch angle.
Example 6 includes the method according Claim 1, wherein the current value of the load pitch angle is determined by subtraction of the average value of the dynamic pitch angle from the average value of the pitch angle.
Example 7 includes the method according to Claim 1, wherein at least one camera is utilized to determine the average value of the pitch angle.
Example 8 includes the method according to Claim 1, including determining a deviation of the headlight from a setting position of the headlight based on the pitch angle of the vehicle relative to the surface, and adapting the setting of the headlight based on the deviation.
Example 9 includes an apparatus for luminous range control of a headlight of a vehicle, the apparatus comprising a gravitation sensor for determining, at a standstill of the vehicle, a change of a load pitch angle of the vehicle, an acceleration sensor for determining an average value of the pitch angle of the vehicle and an average value of a dynamic pitch angle of the vehicle as the vehicle is driven in a calibration phase, and a current value of the dynamic pitch angle, machine readable instructions, and programmable circuitry to execute the instructions to determine a current value of the load pitch angle of the vehicle based on the average value of the pitch angle and the average value of the dynamic pitch angle, determine, based on the current value of the load pitch angle and the current value of the dynamic pitch angle, a pitch angle of the vehicle relative to a surface on which the vehicle stands, and control an orientation of the headlight of the vehicle based on the pitch angle of the vehicle relative to the surface.
Example 10 includes the apparatus according to Claim 9, wherein the average value of the pitch angle and the average value of the dynamic pitch value are determined in response to the determination of the change of the load pitch angle of the vehicle.
Example 11 includes the apparatus according to Claim 9, wherein the change of the load pitch angle of the vehicle is determined based on a measured gravitation angle of the gravitation sensor in relation to a stored gravitation angle.
Example 12 includes the apparatus according to Claim 9, wherein the programmable circuitry is to determine at least one of the current value of the dynamic pitch angle or the average value of the dynamic pitch angle is determined based on at least one model.
Example 13 includes the apparatus according to Claim 9, wherein the programmable circuitry is to determine the current value of the load pitch angle based on subtraction of the average value of the dynamic pitch angle from the average value of the pitch angle.
Example 14 includes the apparatus according to Claim 9, wherein the programmable circuitry is to determine a deviation of the headlight from a setting position of the headlight, and adapt the setting of the headlight based on the deviation.
Example 15 includes a non-transitory machine readable storage medium comprising instructions to cause programmable circuitry to at least determine, at a standstill of a vehicle, a change of a load pitch angle of the vehicle, determine, as the vehicle is driven, (i) an average value of a pitch angle of the vehicle and (ii) an average value of a dynamic pitch angle of the vehicle, determine a current value of the dynamic pitch angle, determine a current value of the load pitch angle based on the average value of the pitch angle and the average value of the dynamic pitch angle, determine, based on the current value of the load pitch angle and the current value of the dynamic pitch angle, the pitch angle of the vehicle, and control an orientation of a headlight of the vehicle based on the pitch angle of the vehicle.
Example 16 includes the machine readable storage medium as defined in Claim 15, wherein the average value of the pitch angle and the average value of the dynamic pitch value are determined during a calibration time window of the vehicle.
Example 17 includes the machine readable storage medium as defined in Claim 15, wherein the average value of the pitch angle and the average value of the dynamic pitch value are determined in response to the change of the load pitch angle of the vehicle.
Example 18 includes the machine readable storage medium as defined in Claim 15, wherein the orientation of the headlight is controlled based on a light cone of the headlight with respect to a surface on which the vehicle stands.
Example 19 includes the machine readable storage medium as defined in Claim 15, wherein the current value of the load pitch angle is determined based on subtraction of the average value of the dynamic pitch angle from the average value of the pitch angle.
Example 20 includes the machine readable storage medium as defined in Claim 15, wherein the instructions cause the programmable circuitry to determine a deviation of the headlight from a setting position of the headlight, and adapt the setting of the headlight based on the deviation.

What is claimed is:

1. A method to determine a pitch angle of a vehicle relative to a surface on which the vehicle stands for luminous range control of a headlight of the vehicle, the method comprising:
determining, at a standstill of the vehicle, a change of a load pitch angle of the vehicle based on output from a gravitation sensor;
determining, as the vehicle is driven, an average value of the pitch angle of the vehicle and an average value of a dynamic pitch angle of the vehicle, the average value of the dynamic pitch angle determined via output from an acceleration sensor;
determining a current value of the dynamic pitch angle via the output from the acceleration sensor;
determining a current value of the load pitch angle of the vehicle based on the average value of the pitch angle and the average value of the dynamic pitch angle;
determining, based on the current value of the load pitch angle and the current value of the dynamic pitch angle, the pitch angle of the vehicle relative to the surface; and
controlling an orientation of the headlight of the vehicle based on the pitch angle of the vehicle relative to the surface.

2. The method according to claim 1, wherein the average value of the pitch angle and the average value of the dynamic pitch value are determined during a calibration time window based on the determination of the change of the load pitch angle of the vehicle.

3. The method according to claim 1, wherein the change of the load pitch angle of the vehicle is determined based on a measured gravitation angle of the gravitation sensor in relation to a stored gravitation angle.

4. The method according to claim 1, wherein the current value of the dynamic pitch angle of the vehicle is determined based on a model.

5. The method according to claim 1, wherein the average value of the dynamic pitch angle is determined based on a model for determining the dynamic pitch angle.

6. The method according claim 1, wherein the current value of the load pitch angle is determined by subtraction of the average value of the dynamic pitch angle from the average value of the pitch angle.

7. The method according to claim 1, wherein at least one camera is utilized to determine the average value of the pitch angle.

8. The method according to claim 1, including:
determining a deviation of the headlight from a setting position of the headlight based on the pitch angle of the vehicle relative to the surface; and
adapting the setting of the headlight based on the deviation.

9. An apparatus for luminous range control of a headlight of a vehicle, the apparatus comprising:
a gravitation sensor for determining, at a standstill of the vehicle, a change of a load pitch angle of the vehicle;
an acceleration sensor for determining:
an average value of the pitch angle of the vehicle and an average value of a dynamic pitch angle of the vehicle as the vehicle is driven in a calibration phase, and
a current value of the dynamic pitch angle;
machine readable instructions; and
programmable circuitry to execute the instructions to:
determine a current value of the load pitch angle of the vehicle based on the average value of the pitch angle and the average value of the dynamic pitch angle,
determine, based on the current value of the load pitch angle and the current value of the dynamic pitch angle, a pitch angle of the vehicle relative to a surface on which the vehicle stands, and
control an orientation of the headlight of the vehicle based on the pitch angle of the vehicle relative to the surface.

10. The apparatus according to claim 9, wherein the average value of the pitch angle and the average value of the dynamic pitch value are determined in response to the determination of the change of the load pitch angle of the vehicle.

11. The apparatus according to claim 9, wherein the change of the load pitch angle of the vehicle is determined based on a measured gravitation angle of the gravitation sensor in relation to a stored gravitation angle.

12. The apparatus according to claim 9, wherein the programmable circuitry is to determine at least one of the current value of the dynamic pitch angle or the average value of the dynamic pitch angle is determined based on at least one model.

13. The apparatus according to claim 9, wherein the programmable circuitry is to determine the current value of the load pitch angle based on subtraction of the average value of the dynamic pitch angle from the average value of the pitch angle.

14. The apparatus according to claim 9, wherein the programmable circuitry is to:
determine a deviation of the headlight from a setting position of the headlight; and
adapt the setting of the headlight based on the deviation.

15. A non-transitory machine readable storage medium comprising instructions to cause programmable circuitry to at least:
determine, at a standstill of a vehicle, a change of a load pitch angle of the vehicle;
determine, as the vehicle is driven, (i) an average value of a pitch angle of the vehicle and (ii) an average value of a dynamic pitch angle of the vehicle;
determine a current value of the dynamic pitch angle;
determine a current value of the load pitch angle based on the average value of the pitch angle and the average value of the dynamic pitch angle;
determine, based on the current value of the load pitch angle and the current value of the dynamic pitch angle, the pitch angle of the vehicle; and
control an orientation of a headlight of the vehicle based on the pitch angle of the vehicle.

16. The machine readable storage medium as defined in claim 15, wherein the average value of the pitch angle and the average value of the dynamic pitch value are determined during a calibration time window of the vehicle.

17. The machine readable storage medium as defined in claim 15, wherein the average value of the pitch angle and the average value of the dynamic pitch value are determined in response to the change of the load pitch angle of the vehicle.

18. The machine readable storage medium as defined in claim 15, wherein the orientation of the headlight is controlled based on a light cone of the headlight with respect to a surface on which the vehicle stands.

19. The machine readable storage medium as defined in claim 15, wherein the current value of the load pitch angle is determined based on subtraction of the average value of the dynamic pitch angle from the average value of the pitch angle.

20. The machine readable storage medium as defined in claim 15, wherein the instructions cause the programmable circuitry to:
determine a deviation of the headlight from a setting position of the headlight; and
adapt the setting of the headlight based on the deviation.
